(19) United States
(12) Patent Application Publication
(10) Pub. No.: US 2015/0079909 A1
(43) Pub. Date: Mar. 19, 2015

(54) DYNAMIC FREQUENCY PLAN

(71) Applicant: QUALCOMM Incorporated, San Diego, CA (US)

(72) Inventors: Carlos SOLEDADE, Nederland, CO (US); Ajay BAWALE, San Diego, CA (US); Graham ROFF, San Diego, CA (US); Girish BHAT, San Diego, CA (US)

(21) Appl. No.: 14/302,301

(22) Filed: Jun. 11, 2014

Related U.S. Application Data
(60) Provisional application No. 61/877,855, filed on Sep. 13, 2013.

(51) Int. Cl. H04B 15/02

(52) U.S. Cl. CPC H04B 15/02
USPC 455/63.3

(57) ABSTRACT

In one configuration, an apparatus and a method to operate the apparatus are provided. The apparatus includes at least one processor configured to receive operating information indicating a set of operating frequencies from a first circuit and to select an operating frequency from the set of operating frequencies. The at least one processor is further arranged to configure an operation of a second circuit based on the selected operating frequency. In another configuration, the apparatus includes at least one processor configured to select a set of operating frequencies based a radio frequency operation and to transmit operating information indicating the set of operating frequencies to a control circuit.

### CROSS-REFERENCE TO RELATED APPLICATION(S)

This application claims the benefit of U.S. Provisional Application Ser. No. 61/877,855, titled “METHOD TO REDUCE COUPLED DE-SENSE USING DYNAMIC FREQUENCY PLAN CONTROL BASED ON NETWORK OPERATING MODE” and filed on Sep. 13, 2013, which is expressly incorporated by reference herein in its entirety.

### BACKGROUND

1. Field

The present disclosure relates generally to electronic devices, and more particularly, to electronic devices with reduced interference among the electronic components or circuits.

2. Background

Wireless communication technologies and electronic mobile devices (e.g., cellular phones, tablets, laptops, etc.) have grown in popularity and use over the past several years. Increasingly, the mobile devices have grown in complexity and now commonly include multiple processors and other resources that allow the mobile device users to execute complex and power intensive software applications (e.g., web browsers, video streaming applications, etc.). At the same time, the mobile devices have continued to reduce in size.

One such mobile device may include, in addition to the processors, electronic components/circuits such as a modem for the communication functions, a graphic unit for the display, a global positioning system (GPS) for locating the mobile device, and memory systems. These electronic components/circuits may be assembled or integrated in various ways to reduce the sizes of the electronic devices. For example, the various electronic components/circuits may be integrated on a common substrate, assembled using substrate-on-substrate packaging, or packaged using package-on-package (POP) technology.

### SUMMARY

Aspects of an apparatus are disclosed. The apparatus includes at least one processor configured to receive operating information indicating a set of operating frequencies from a first circuit and to select an operating frequency from the set of operating frequencies. The at least one processor is further arranged to configure an operation of a second circuit based on the selected operating frequency. In another configuration, the apparatus includes at least one processor configured to select a set of operating frequencies based a radio frequency operation and to transmit operating information indicating the set of operating frequencies to a control circuit.

Aspects of a method for operating an apparatus are disclosed. The method includes receiving operating information indicating a set of operating frequencies from a first circuit, selecting an operating frequency from the set of operating frequencies, and configuring an operation of a second circuit based on the selected operating frequency.

Further aspects of an apparatus are disclosed. The apparatus includes at least one processor configured to select a set of operating frequencies based a radio frequency operation and to transmit operating information indicating the set of operating frequencies to a control circuit.

Aspects of a method for operating an apparatus are disclosed. The method includes selecting a set of operating frequencies based a radio frequency operation and transmitting the set of operating frequencies to a control circuit.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatus and methods will now be presented in the detailed description by way of example, and not by way of limitation, with reference to the accompanying drawings, wherein:

FIG. 1 is a wireless communication application of an exemplary embodiment.

FIG. 2 is a block diagram illustrating a mobile device incorporating an exemplary embodiment.

FIG. 3 is a flow diagram of an exemplary embodiment.

FIG. 4 is another flow diagram of an exemplary embodiment.

FIG. 5 is an example of a hardware implementation of an exemplary embodiment.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

Various apparatus and methods presented throughout this disclosure may be implemented in various forms of hardware. By way of example, any of these apparatus or methods, either alone or in combination, may be implemented as an integrated circuit, or as part of an integrated circuit. The integrated circuit may be an end product, such as a microprocessor, a digital signal processor (DSP), an application specific integrated circuit (ASIC), programmable logic, or any other suitable integrated circuit. Alternatively, the integrated circuit may be integrated with other chips, discrete circuit elements, and/or other components as part of either an intermediate product, such as a motherboard, or an end product. The end product can be any suitable product that includes integrated circuits, including by way of example, a cellular phone, personal digital assistant (PDA), laptop computer, a desktop computer (PC), a computer peripheral device, a multimedia device, a video device, an audio device, a GPS, a wireless sensor, or any other suitable device.

The word “exemplary” is used herein to mean serving as an example, instance, or illustration. Any embodiment described herein as “exemplary” is not necessarily to be construed as preferred or advantageous over other embodiments. Likewise, the term “embodiment” of an apparatus or method does not require that all embodiments of the invention include the described components, structure, features, functionality, processes, advantages, benefits, or modes of operation.

The terms “connected,” “coupled,” or any variant thereof, mean any connection or coupling, either direct or indirect, between two or more elements, and can encompass the presence of one or more intermediate elements between two elements that are “connected” or “coupled” together. The coupling or connection between the elements can be physical, logical, or a combination thereof. As used herein, two elements can be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of the stated features, integers, steps, operations, elements, and/or components, but do not preclude the presence or addition of one or more other features, integers, steps, operations, elements, components, and/or groups thereof

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media

As electronic mobile devices add more features and reduce in size, the various electronic components/circuits of the mobile devices may need to reside in denser packages, resulting in unwanted and/or unavoidable proximity between circuits and components. As a result, the radio frequency (RF) operation of an electronic component/circuit may interfere with or be interfered with by the other electronic components/circuits. For example, POP is a package technology that places a packaged memory (usually in a ball-grid-array, e.g. BGA package) directly on top of a packaged processor. The processor may include a modem circuit integrated therein. However, signals generated from the memory operation may interfere with the RF operations of the modem. Various aspects of a control circuit that manages the interferences among the various electronic components/circuits are presented below. Examples of the control circuit may include (but not be limited to) a part of a processor operating according to software instructions that receives and generates signals from the electronic components/circuits as described below.

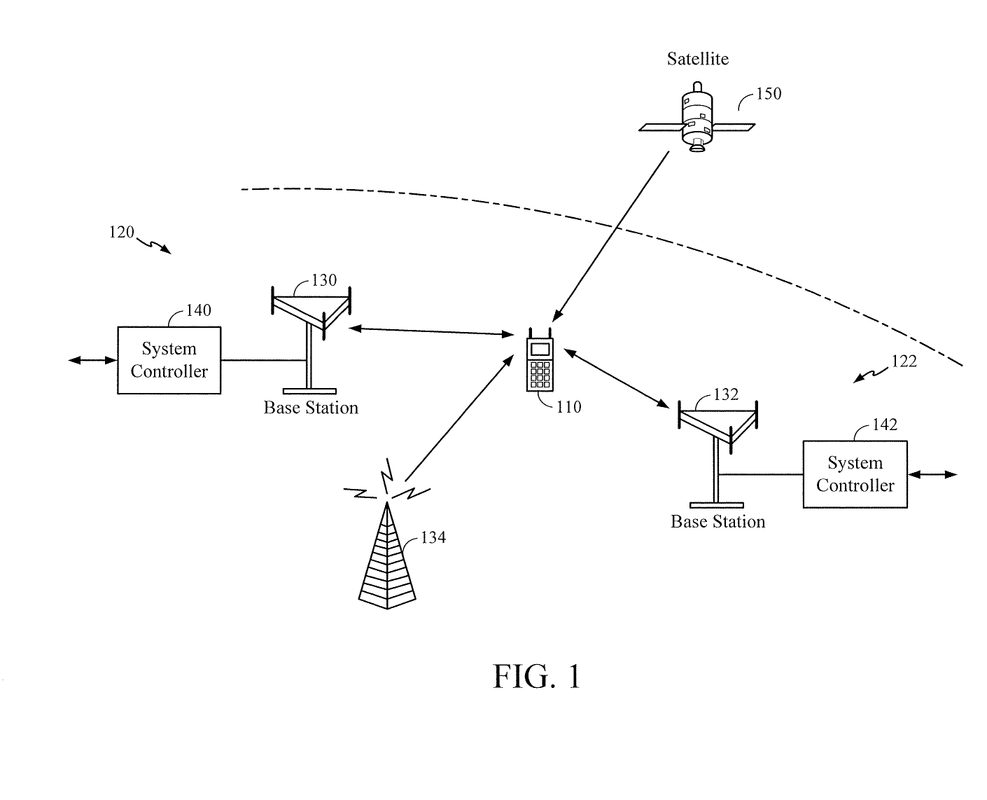

FIG. 1 is a wireless communication application of an exemplary embodiment. A wireless mobile device 110 communicates with different wireless communication systems 120, 122. The wireless systems 120, 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), CDMA 1X or cdma2000, Time Division Synchronous Code Division Multiple Access (TD-SCDMA), or some other version of CDMA. TD-SCDMA is also referred to as Universal Terrestrial Radio Access (UTRA) Time Division Duplex (TDD) 1.28 Mcps Option or Low Chip Rate (LCR). LTE supports both frequency division duplexing (FDD) and time division duplexing (TDD). For example, the wireless system 120 may be a GSM system, and the wireless system 122 may be a WCDMA system. As another example, the wireless system 120 may be an LTE system, and the wireless system 122 may be a CDMA system.

For simplicity, the diagram 100 shows the wireless system 120 including one base station 130 and one system controller 140, and the wireless system 122 including one base station 132 and one system controller 142. In general, each wireless system may include any number of base stations and any set of network entities. Each base station may support communication for wireless devices within the coverage of the base station. The base stations may also be referred to as a Node B, an evolved Node B (eNB), an access point, a base transceiver station, a radio base station, a radio transceiver, a transceiver function, a basic service set (BSS), an extended service set (ESS), or some other suitable terminology. The mobile device 110 may also be referred to as a user equipment (UE), a mobile device, a remote device, a wireless device, a wireless communications device, a station, a mobile station, a subscriber station, a mobile subscriber station, a terminal, a mobile terminal, a remote terminal, a wireless terminal, an access terminal, a client, a mobile client, a mobile unit, a subscriber unit, a wireless unit, a remote unit, a handset, a user agent, or some other suitable terminology. The mobile device 110 may be a cellular phone, a smartphone, a tablet, a wireless modem, a personal digital assistant (PDA), a handheld device, a laptop computer, a smartbook, a netbook, a cordless phone, a wireless local loop (WLL) station, or some other similar functioning device.

The mobile device 110 may be capable of communicating with the wireless system 120 and/or 122. The mobile device 110 may also be capable of receiving signals from broadcast stations, such as the broadcast station 134. The mobile device 110 may also be capable of receiving signals from satellites, such as the satellite 150, in one or more global navigation satellite systems (GNSS). The mobile device 110 may support one or more radio technologies for wireless communication such as GSM, WCDMA, cdma2000, LTE, 802.11, etc.

The mobile device 110 may communicate with a base station in a wireless system via the downlink and the uplink. The downlink (or forward link) refers to the communication link from the base station to the wireless device, and the uplink (or reverse link) refers to the communication link from the wireless device to the base station. A wireless system may utilize TDD and/or FDD. For TDD, the downlink and the uplink share the same frequency, and downlink transmissions and uplink transmissions may be sent on the same frequency in different time periods. For FDD, the downlink and the uplink are allocated separate frequencies. Downlink transmissions may be sent on one frequency, and uplink transmissions may be sent on another frequency. Some exemplary radio technologies supporting TDD include GSM, LTE, and TD-SCDMA. Some exemplary radio technologies supporting FDD include WCDMA, cdma2000, and LTE. Accordingly, a mobile device 110 may engage in RF operations of transmitting or receiving RF signals of various frequencies or bands. At one time, various RF bands may be active for the mobile device 110.

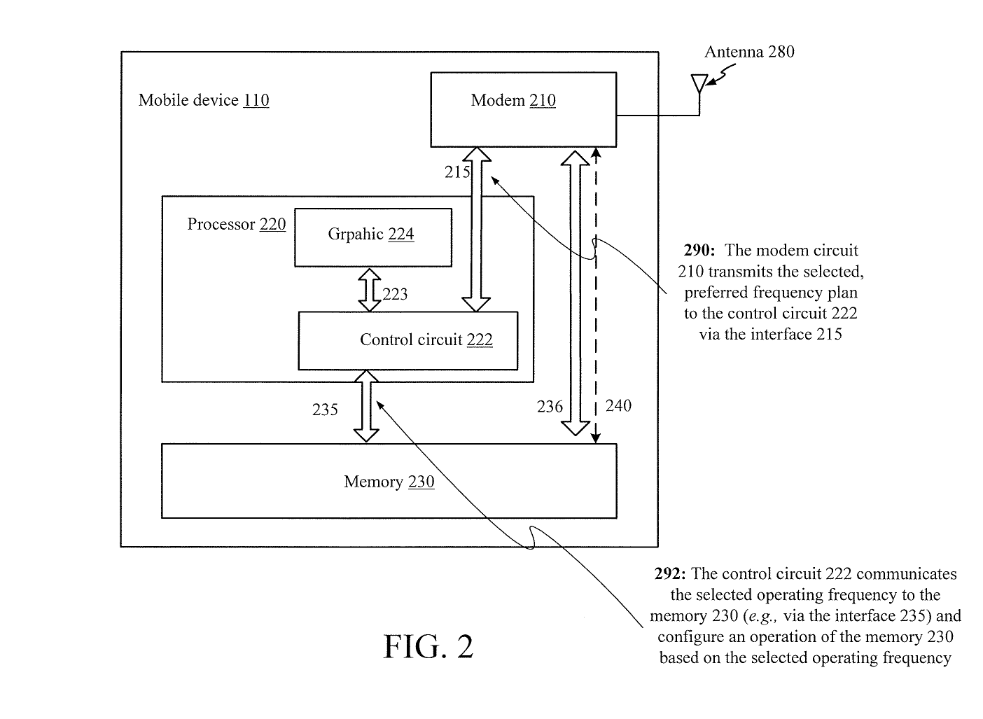

FIG. 2 is a block diagram illustrating a mobile device 110 incorporating an exemplary embodiment. The mobile device 110 includes a modem circuit 210. An example of the modem circuit 210 may include a baseband processor and/or a transceiver. The modem circuit 210 is connected to an antenna 280 for the RF wireless communication (e.g., the uplink transmission and the down link transmission described above). In one example, the modem circuit 210 is configured to receive and transmits RF signals at various RF bands (frequencies). The mobile device 110 further includes a processor 220 coupled to the modem circuit 210 via an interface 215. An example of the processor 220 is known as an application processor and handles various functions. For example, the processor 220 may include a graphic unit for the display, a GPS component/circuit, and an audio processing unit for handling telephony functions, etc. As an example, the processor 220 is shown to include a graphic circuit 224. The processor 220 further includes a control circuit 222 coupled to the graphic circuit 224 via an interface 223. Examples of the control circuit 222 include various execution cores and memory control blocks. Further, examples of the control circuit 222 may include circuits to implement the required logic, circuits to receive or generate signals as instructed by a processor, or circuits to receive or generate signals as instructed by instructions stored on a computer-readable medium. The control circuit 222 is coupled to the modem circuit 210 via the interface 215.

The mobile device 110 further includes a memory 230 coupled to the control circuit 222 via an interface 235 (e.g., a memory interface) and coupled to the modem circuit 210 via an interface 236. The memory 230 may be a dynamic random access memory (DRAM) in, for example, a BGA package. As an example, the memory 230 may be a double-data-rate (DDR) DRAM having an output clock of 533 MHz. Thus, the data interface of the interface 235 would operate at 533 MHz. In a DDR memory, the memory outputs the data at both the rising edge and the falling edge of an output clock. Therefore, the memory 230 may output data at 1066 MHz at the 533 MHz interface.

As an example, the memory 230 is disposed on the modem circuit 210 in a POP assembly. In certain cases, the interface frequency (e.g., 533 MHz) of the memory 230 may fall on harmonics of an active RF band of the modem circuit 210. In such case, the memory 230 may interfere 240 (e.g., electrical and magnetic or EM coupling) with the operation of the modem circuit 210. In an example, the EM coupling interference 240 may result in a ground noise in the modem circuit 210. In a case where the interface frequency (e.g., 533 MHz) of the memory 230 falls on the harmonics of a receiving band, the receiving performance may be impacted. The issue may be worse if the interface 215 utilizes a single-ended interface with the modem circuit 210.

The exemplary embodiment allows the modem circuit 210 to select a frequency plan, which includes information indicating a set of operating frequencies (e.g., the interface frequencies) for the memory 230. For example, the mobile device 110 may be configured to operate at a frequency plan A including operating frequencies 533 MHz, 400 MHz, and 200 MHz. A frequency plan B may include operating frequencies 513.6 MHz, 400 MHz, and 200 MHz. A frequency plan C may include operating frequencies 513.6 MHz, 420 MHz, and 200 MHz. Each mobile device 110 may be configured for different frequency plans because different radio access technologies may be supported. The modem circuit 210 may select a preferred frequency plan based on a currently active RF band to avoid or reduce the EM coupling interference 240 from the memory 230 (294). For example, the currently active RF bands include an RF frequency which may be interfered with by the operating frequency 533 MHz (e.g., 533 MHz falls on the harmonics of the currently active RF bands). In response, the modem 210 selects the frequency B, which does not include the operating frequency 533 MHz.

The modem circuit 210 may transmit the selected, preferred frequency plan (e.g., frequency plan B) to the control circuit 222 via the interface 215 (290). The modem circuit 210 may change operations and therefore, the active RF bands. As a result, the modem circuit 210 may dynamically change the selected frequency plan and transmit the selected frequency plan to the control circuit 222. In such case, the interface 215 may be an asynchronous interface to avoid any timeline violations.

Moreover, the modem circuit 210 may further transmit a performance request regarding the performance of the memory 230 to the control circuit 222 via the interface 215. For example, the modem circuit 210 may need only a nominal performance for the current RF operation and transmit the nominal performance request to the control circuit 222. Other electronic components/circuits, such as the graphic circuit 224, may also transmit the performance requests to the control circuit 222. The control circuit 222 may select an operating frequency of the memory 230 from the frequency plan received from the modem circuit 210, based on the performance requests received from, e.g., the modem circuit 210 and the graphic circuit 224.

In one example, the control circuit 222 may start the mobile device 110 from a default frequency plan, such as the frequency plan A. The modem circuit 210 initializes and, based on its current active RF bands, selects a frequency plan and the performance request. The modem circuit 210 then transmits the selected frequency plan (e.g., frequency plan B) and performance request to the control circuit 222 via an asynchronous interface 215. The control circuit 222 further receives the performance request from the graphic circuit 224. The control circuit 222 then selects an operating frequency from the received frequency plan (e.g., frequency plan B), based on the received performance requests. In one example, when both the performance requests are low, the control circuit 222 may select the lowest operating frequency from the received frequency plan B to reduce the EM coupling interference 240 further. In another example, the graphic circuit 224 may request a turbo performance from the memory 230. In such case, the control circuit 222 may select a high operating frequency from the received frequency plan B to meet the performance request of the graphic circuit 224.

The control circuit 222 may communicate the selected operating frequency to the memory 230 (e.g., via the interface 235) and configure an operation of the memory 230 based on the selected operating frequency (292). The memory 230 may, in response to the received selected operating frequency, arrange to operate at the selected operating frequency (e.g., the memory interface operates at the selected operating frequency). As the modem circuit 210 continues to operate, the active RF bands change. The modem circuit 210 may select a new frequency plan (e.g. frequency plan C) and the performance request based on the new active RF bands. The modem circuit 210 may then transmit the selected frequency plan C and the performance request to the control circuit 222 via the asynchronous interface 215. The control circuit 222 may then select an operating frequency from the new frequency plan C and communicate to the memory 230, as described above.

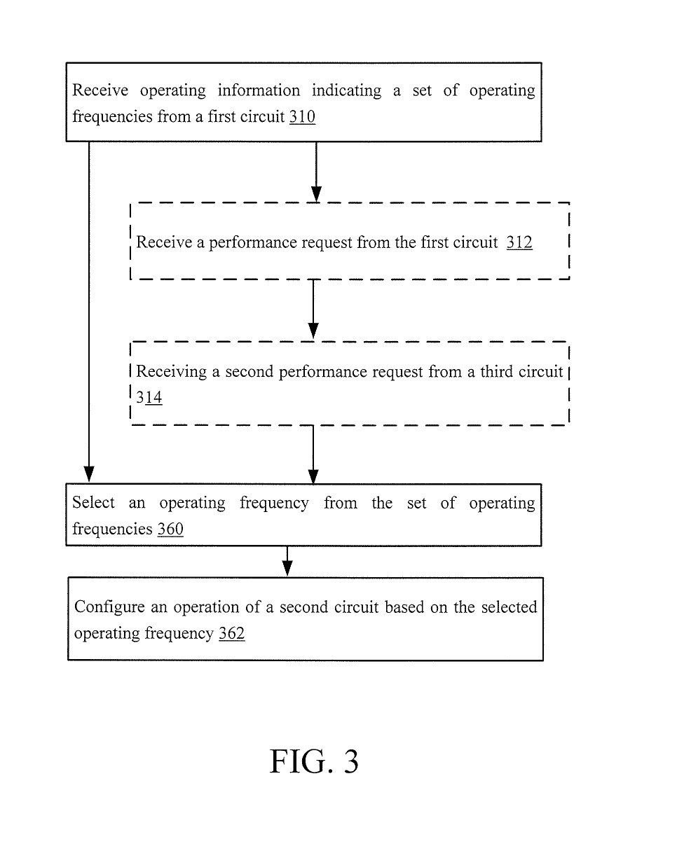

FIG. 3 is a flowchart of the operations of an exemplary embodiment (e.g. the control circuit 222). The steps illustrated in dotted lines may be optional. At 310, operating information indicating a set of operating frequencies (e.g., the frequency plan B including operating frequencies 513.6 MHz, 400 MHz, and 200 MHz) is received from a first circuit (e.g., the modem circuit 210). At 312, a performance request is received from the first circuit (e.g., the modem circuit 210). At 314, a second performance request is received from a third circuit (e.g., the graphic circuit 224). At 360, an operating frequency is selected from the set of operating frequencies. At 362, an operation of the second circuit (e.g., the graphic circuit 224) is configured based on the operating frequency. Examples of these steps are described above with FIGS. 1 and 2.

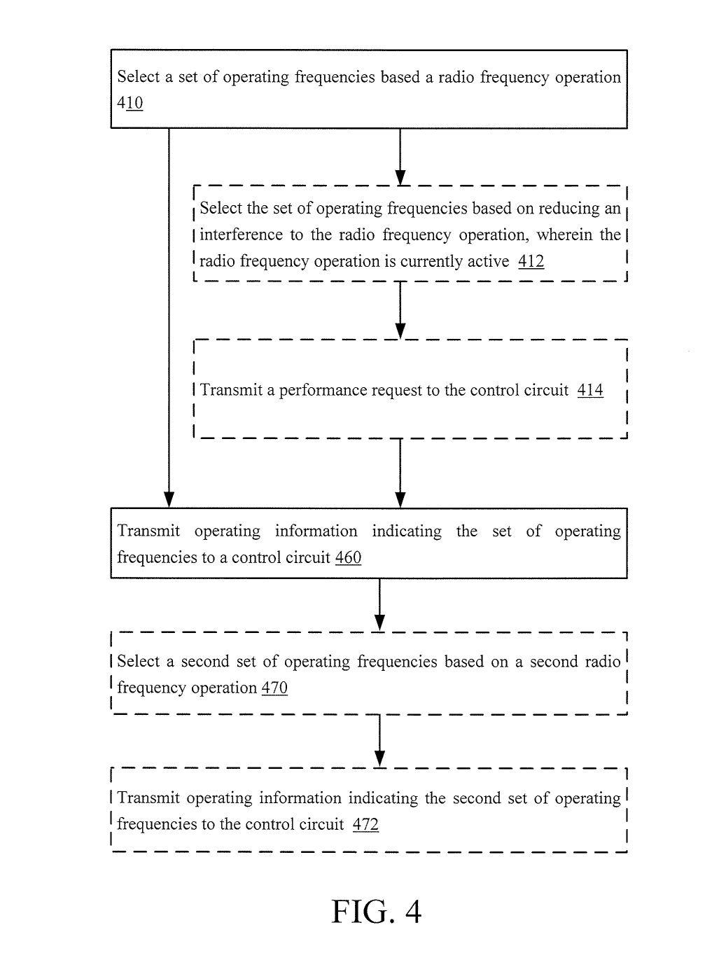

FIG. 4 is another flowchart of the operations of an exemplary embodiment (e.g. the modem circuit 210). The steps illustrated in dotted lines may be optional. At 410, a set of operating frequencies (e.g., the frequency plan B including operating frequencies 513.6 MHz, 400 MHz, and 200 MHz) is selected based on a radio frequency operation. At 412, the set of operating frequencies (e.g., the frequency plan B including operating frequencies 513.6 MHz, 400 MHz, and 200 MHz) is selected based on reducing an interference to the radio frequency operation (e.g., the interference 410 fro, the memory 230). The radio frequency operation is currently active (e.g., the currently active RF bands). At 414, a performance request is transmitted to a control circuit (e.g., the control circuit 222). At 460, operating information indicating the set of operating frequencies is transmitted to the control circuit. At 470, a second set of operating frequencies (e.g., the frequency plan C including the operating frequencies 513.6 MHz, 420 MHz, and 200 MHz) is selected based on a second radio frequency operation. AT 472, operating information indicating the second set of operating frequencies is transmitted to the control circuit (e.g., the control circuit 222). Examples of these steps are described above with FIGS. 1 and 2.

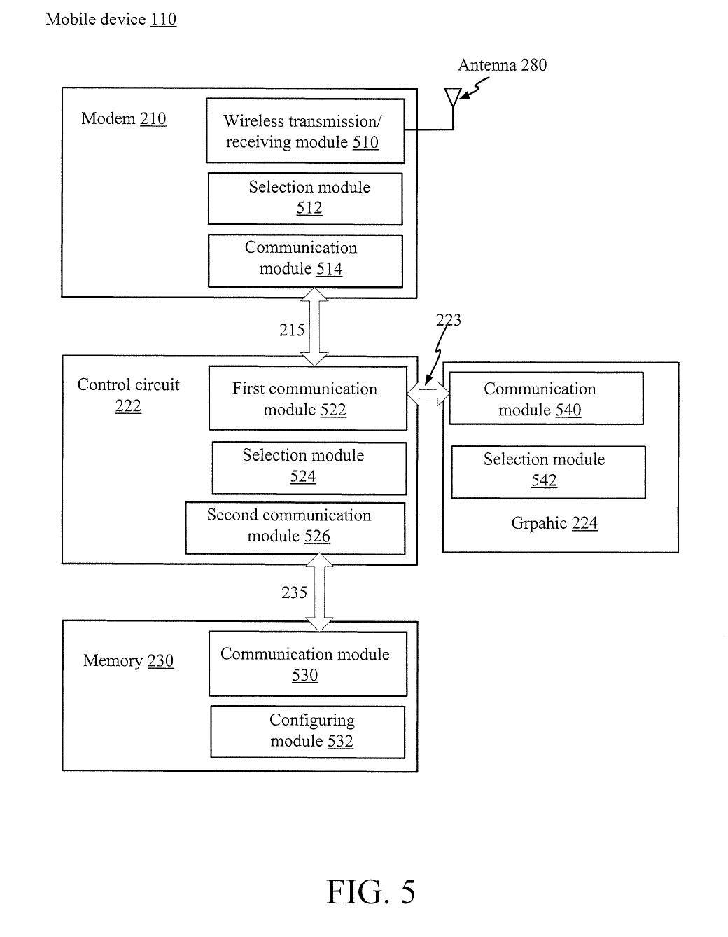

FIG. 5 is an example of a hardware implementation of an exemplary embodiment. Various hardware modules are shown. The hardware modules may be implemented with circuits and/or a processor system (e.g, an execution core within a processor). An example of the hardware modules may include a circuit for generating a signal as instructed by the processor system, which operates in accordance with algorithms illustrated in FIG. 3 and/or FIG. 4. The hardware modules provide the means to implement the functions shown in FIG. 3 and/or FIG. 4.

The modem circuit 210 includes a wireless transmission/receiving module 510, a selection module 512, and a communication module 514. The wireless transmission/receiving module 510 is connected to the antenna 280 and is configured to perform RF operations such as transmitting and/or receiving RF signals. The selection module 512 is configured to select a set of operating frequencies based the RF operations. The selection of the set of operating frequencies may be to reduce interferences with the RF operations. The communication module 514 is configured to transmit or communicates the operating information (e.g., the frequency plans) indicating the selected set of operating frequencies to a control circuit 222 via an interface 215. The interface 215 may be a bus or a signal line, and an example of the communication module 514 may be drivers for the bus or signal line. The transmission or communication may be asynchronous.

Moreover, the selection module 512 may further be configured to determine a performance request based on a performance demand of the RF operations. The selection module 512 may further be configured to select a second set of operating frequencies based on a second RF operation (e.g., to reduce an interference to the second RF operation). The communication module 514 may further be configured to communicate or transmit the performance request to the control circuit 222 via an interface 215. The communication module 514 may further be configured to communicate or transmit the second operating information (e.g., the frequency plans) indicating the selected second set of operating frequencies to a control circuit 222 via the interface 215.

The control circuit 222 includes a first communication module 522, a selection module 524, and a second communication module 526. The first communication module 522 may be configured to receive the operating information (e.g., the frequency plans) indicating a set of operating frequencies from the communication module 514 of the modem circuit 210. The interface 215 may be a bus or a signal line, and an example of the first communication module 522 may be a receiver or input circuit for the bus or signal line. The receiving of the operating information may be asynchronous. The selection module 524 may be configured to select an operating frequency from the received set of operating frequencies. The second communication module 526 may be configured to transmit or communicate the selected operating frequency to the memory 230 via an interface 235, for configuring an operation of the memory 230 based on the selected operating frequency. In one example, the configured operation of the memory 230 may be an interface frequency of the memory 230. In one example, the interface 235 may be a bus or a signal line, and an example of the second communication module 526 may be drivers for the bus or signal line.

The first communication module 522 may be configured to receive a performance request from the modem circuit 210 and/or a performance request from the graphic circuit 224 via an interface 223. In one example, the interface 223 may be a bus or a signal line, and an example of the first communication module 522 may be a receiver or input circuit for the bus or signal line. The selection module 524 may be configured to select the operating frequency from the received set of operating frequencies based on the performance request from the modem circuit 210 and/or the performance request from the graphic circuit 224.

The memory 230 includes a communication module 530 and a configuring module 532. The communication module 530 may be configured to receive the selected operating frequency from the control circuit 222 via the interface 235, for configuring the operation of the memory 230 based on the selected operating frequency. In one example, the interface 235 may be a bus or a signal line, and an example of the communication module 530 may be a receiver or input circuit for the bus or signal line. The configuring module 532 may be arranged to configure the operation (e.g., the interface frequency) of the memory 230. In one example, the configuring module 532 sets the interface frequency of the memory 230.

The graphic circuit 224 includes a communication module 540 and a selection module 542. The communication module 540 may be configured to transmit or communicates a performance request to the control circuit 222 via the interface 223. The interface 223 may be a bus or a signal line, and an example of the communication module 540 may be drivers for the bus or signal line. The selection module 542 may be configured to determine the performance request based on a performance demand of an active operation.

The specific order or hierarchy of blocks in the method of operation described above is provided merely as an example. Based upon design preferences, the specific order or hierarchy of blocks in the method of operation may be re-arranged, amended, and/or modified. The accompanying method claims include various limitations related to a method of operation, but the recited limitations are not meant to be limited in any way by the specific order or hierarchy unless expressly stated in the claims.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. An apparatus, comprising:
a memory; and
at least one processor coupled to the memory and configured to:
receive operating information indicating a set of operating frequencies from a first circuit;
select an operating frequency from the set of operating frequencies; and
configure an operation of a second circuit based on the selected operating frequency.

2. The apparatus of claim 1, wherein the operating information is received asynchronously.

3. The apparatus of claim 1, wherein the operation of the second circuit is an interface operation.

4. The apparatus of claim 1, wherein the at least one processor is further configured to receive a performance request from the first circuit.

5. The apparatus of claim 4, wherein the at least one processor is configured to select the operating frequency based on the performance request from the first circuit.

6. The apparatus of claim 4, wherein the at least one processor is further configured to receive a second performance request from a third circuit.

7. The apparatus of claim 6, wherein the at least one processor is further configured to select the operating frequency based on the performance request by the first circuit and the second performance request by the third circuit.

8. A method for operating an electronic system, comprising:
receiving operating information indicating a set of operating frequencies from a first circuit;
selecting an operating frequency from the set of operating frequencies;
configuring an operation of a second circuit based on the selected operating frequency.

9. The method of claim 8, wherein the set of operating frequencies is received asynchronously by the first circuit.

10. The method of claim 8, wherein the operation of the second circuit comprises an interface operation of the second circuit.

11. The method of claim 8, further comprising receiving a performance request from the first circuit.

12. The method of claim 11, wherein the selecting the operating frequency from the set of operating frequencies is based on the performance request from the first circuit.

13. The method of claim 11, further comprising receiving a second performance request from a third circuit.

14. The method of claim 13, wherein the selecting the operating frequency is based on the performance request from the first circuit and the second performance request from the third circuit.

15. An apparatus, comprising:
a memory; and
at least one processor coupled to the memory and configured to:
select a set of operating frequencies based a radio frequency operation; and
transmit operating information indicating the set of operating frequencies to a control circuit.

16. The apparatus of claim 15, wherein the at least one processor is configured to transmit the operating information indicating the set of operating frequencies to the control circuit asynchronously.

17. The apparatus of claim 15, wherein the at least one processor is further configured to transmit a performance request to the control circuit.

18. The apparatus of claim 17, wherein the at least one processor is further configured to determine the performance request based on a performance demand of the radio frequency operation.

19. The apparatus of claim 15, wherein the at least one processor is configured to select the set of operating frequencies to reduce an interference to the radio frequency operation, wherein the radio frequency operation is currently active.

20. The apparatus of claim 15, wherein the at least one processor is further configured to:
select a second set of operating frequencies based on a second radio frequency operation; and
transmit operating information indicating the second set of operating frequencies to the control circuit.

21. A method for operating an electronic system, comprising:
selecting a set of operating frequencies based a radio frequency operation; and
transmitting the set of operating frequencies to a control circuit.

22. The method of claim 21, wherein the transmitting operating information indicating the set of operating frequencies to the control circuit is asynchronous.

23. The method of claim 21, further comprising transmitting a performance request to the control circuit.

24. The method of claim 23, wherein the performance request is determined based on a performance demand of the radio frequency operation.

25. The method of claim 21, wherein the selecting the set of operating frequencies is based on reducing an interference to the radio frequency operation, wherein the radio frequency operation is currently active.

26. The method of claim 21, further comprising:
selecting a second set of operating frequencies based on a second radio frequency operation; and
transmitting operating information indicating the second set of operating frequencies to the control circuit.
